(19) United States
(12) Patent Application Publication
(10) Pub. No.: US 2024/0155017 A1
(43) Pub. Date: May 9, 2024

(54) Method for Processing Data Streams of a Conference Session by a Session Server

(71) Applicant: STREAMWIDE, Paris (FR)

(72) Inventor: Florent PREVITALI, Saint Maur Des Fosses (FR)

(73) Assignee: STREAMWIDE, Paris (FR)

(21) Appl. No.: 18/386,459

(22) Filed: Nov. 2, 2023

(30) Foreign Application Priority Data
Nov. 4, 2022 (FR) 2211519

(51) Int. Cl. H04L 65/70; H04L 9/40; H04L 65/80

(52) U.S. Cl. CPC H04L 65/70; H04L 63/0457; H04L 65/80

(57) ABSTRACT

Examples disclose a method for processing multimedia streams emitted by terminals participating to a conference and encapsulated according to an Internet protocol to the session server that distributes the multimedia streams to the receiver terminals participating to the conference, the method comprising: identifying the encoding codec implemented by each of the terminals participating to the conference; and when the session server receives a plurality of streams originating from a corresponding plurality of emitter terminals participating to the conference, decoding data packets of the plurality of streams received from the emitter terminals; mixing received stream data packets so that a mixed stream is transmitted to the receiver terminals; and encoding in one single step data packets of the mixed stream for each group of receiver terminals implementing the same encoding/decoding codec.

### TECHNICAL FIELD

The present disclosure relates to the field of exchanges of data and streams transiting through networks using Internet protocols in the context of conferences (audio and/or video).

### PRIOR ART

Exchanges of data transiting through networks using Internet protocols are widely used in the context of conferences between remote participants. In particular, several applications allow holding conferences involving many participants, which connect and participate to the conference via a suitable electronic device, or terminal.

A conference between several participants is generally managed, with respect to the bandwidth and to the different audio/video data streams to be processed and transmitted to the different participants, by a session server which centralizes all of the processing operations and transmissions of the data streams.

In this case, the management of the conferences and the processing of the video and audio streams require important computing resources from the processor of the session server. The necessary resources are even more significant as the number of participants is high.

The present disclosure aims to improve this situation.

### SUMMARY

In this respect, a method, implemented by a processor of a session server, is provided, for processing multimedia stream data packets of a conference session to which a plurality of terminals participate, the multimedia stream data packets being sent by at least one emitter terminal amongst the terminals participating to the conference session,
wherein multimedia stream data packets emitted by the terminals participating to the conference are encapsulated according to an Internet protocol and are sent to the session server which distributes the multimedia streams to receiver terminals participating to the conference session,
the method comprising:
identifying the encoding codec implemented by each of the terminals participating to the conference; and
   when the session server receives a plurality of multimedia streams originating from a corresponding plurality of emitter terminals participating to the conference,
decoding data packets of the plurality of multimedia streams received from the emitter terminals;
mixing received multimedia stream data packets so that a mixed multimedia stream is transmitted to the receiver terminals; and
encoding only once data packets of the mixed multimedia streams for each group of receiver terminals implementing the same encoding/decoding codec.

In one variant, when the session server receives a unique multimedia stream originating from a unique emitter terminal participating to the conference, transferring the unique multimedia stream originating from the emitter terminal, without decoding the data streams of the unique multimedia stream, to the receiver terminals implementing the same encoding/decoding codec as that one implemented by the emitter terminal.

In one variant, the data packets of the multimedia streams emitted by the terminals participating to the conference are encrypted, and the method further comprises:
obtaining the encryption key that each terminal applies to encrypt the data packets of their own emitted multimedia streams; and
   when the session server receives a plurality of multimedia streams originating from a corresponding plurality of emitter terminals participating to the conference,
before decoding, decrypting data packets of the plurality of multimedia streams received from the emitter terminals;
after encoding, encrypting only once the mixed and encoded data packets of the multimedia streams of the terminals of the same group of receiver terminals applying the same encryption key, and
   when the session server receives a unique multimedia stream originating from an emitter
terminal participating to the conference,
transferring the unique multimedia stream originating from the emitter terminal, without decrypting data packets of this multimedia stream, to the receiver terminals of each group of receiver terminals implementing the same encoding/decoding codec and applying the same encryption key as the emitter terminal.

In one variant, when the session server receives two multimedia streams originating from two different emitter terminals participating to the conference and implementing the same encoding codec, the method further comprises transferring the multimedia stream received from one emitter terminal to the other emitter terminal, and vice versa, without mixing or decoding.

In one variant wherein the session sever receives two multimedia streams originating from two different emitter terminals participating to the conference implementing the same encoding codec and also having the same encryption key, the transfers of multimedia streams from one emitter terminal to the other emitter terminal, and vice versa, are implemented without decryption by the session server.

In one variant, the method comprises the following prior step:
determining a utilization rate of the processor of the session server; and
   when the utilization rate of the processor of the session server is higher than a predetermined utilization rate,
managing each multimedia stream received by the session server as a unique multimedia stream originating from a unique emitter terminal participating to the conference.

In one variant, a multimedia stream corresponds to an audio stream or a video stream.

In one variant wherein the multimedia streams correspond to audio streams, the method further comprising, before mixing the multimedia streams, selecting a predetermined number of audio streams having the largest volumes among the audio data streams received from the emitter terminals. In this variant, mixing of the multimedia streams corresponds to a limited mixing with the selected audio streams.

Hence, the method according to the present disclosure allows saving computing resources of a processor of a session server ensuring the distribution of the multimedia data streams of a conference session by cleverly aggregating the operations of encoding, and possibly encryption, of the multimedia streams intended for receiver terminals of similar streams (in particular implementing the same encoding) and possibly the same encryption key. Hence, the reduction of the load of the processor of the session server is even more significant as there are participants to the conference session.

Moreover, in some examples, the disclosed method also provides that when the session server receives only one or only two multimedia stream(s) during a determined time interval, the processor executes specific operations which allow saving its computing resources. The Inventor has noticed that, in practice, in a conference session, only one or two participant(s) intervene(s) simultaneously most of the time the session lasts. Consequently, the specific operations proposed to address these particular situations are extremely advantageous and enable the processor to preserve computing resources almost during the whole conference session.

The application also relates to a session server comprising a processor configured to implement any one of the methods described in the present disclosure.

The application also relates to a computer program product including instructions for the implementation of any one of the methods described in the present disclosure when this program is executed by a processor.

Finally, the application relates to a non-transitory computer-readable medium on which is stored a program for the implementation of any one of the methods described in the present disclosure when this program is executed by a processor.

### BRIEF DESCRIPTION OF THE DRAWINGS

Other features, details and advantages will appear upon reading the detailed description hereinafter, and upon analysis of the appended drawings, wherein:

FIG. 1 schematically shows an example of a communication architecture wherein a method for processing multimedia stream data packets of a conference session can be implemented.

FIG. 2 shows an example of a terminal.

FIG. 3 shows an example of a session server.

FIG. 4 shows an example of a method for processing multimedia stream data packets of a conference session.

### DESCRIPTION OF THE EMBODIMENTS

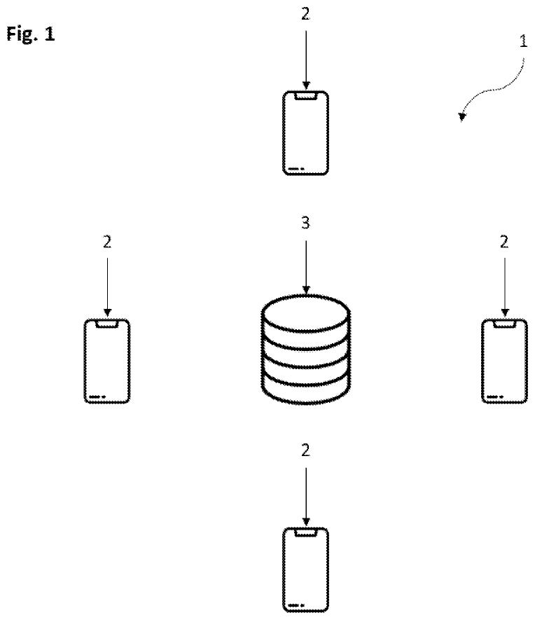

An example of a communication architecture 1 is now described with reference to FIG. 1 in which a method for processing multimedia stream data packets of a conference session to which a plurality of terminals 2 participate may be performed.

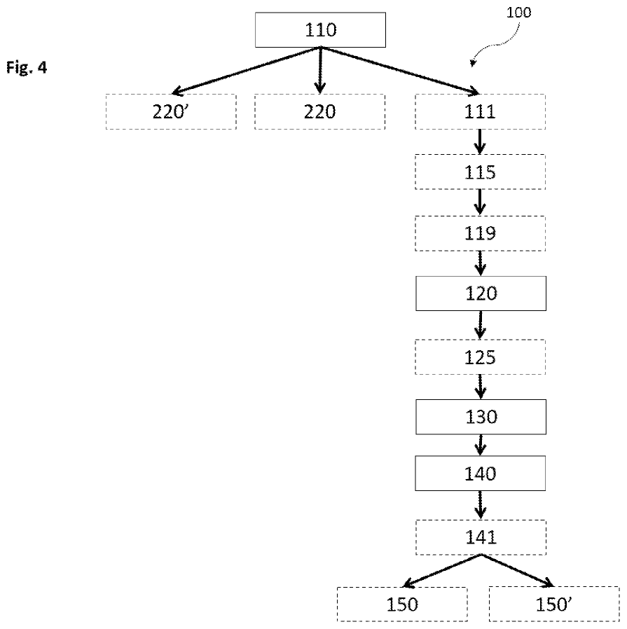

A multimedia stream may correspond to an audio data stream or to a video data stream or to a combination of both. The method for processing multimedia stream data packets disclosed with reference to FIG. 4 may also be applied to an audio data stream as well as to a video data stream unless stated otherwise in the description of the present disclosure. In particular, the operations shown in dotted lines in FIG. 4 are advantageous but optional.

A data stream, or a stream, is defined in the present disclosure as corresponding to at least two successive data packets. An audio data stream, or audio stream, is defined as corresponding to at least two successive audio data packets. A video data stream, or video stream, is defined as corresponding to at least two successive video data packets.

The communication architecture 1 comprises a session server 3 and a plurality of terminals 2. The plurality of terminals 2 participates to a conference session enabling them to exchange multimedia streams with each other, almost in real-time. The multimedia streams emitted by emitter terminals 2 during the conference session are sent to the session server 3 which may distribute them to the receiver terminals 2 participating to the conference session.

A distribution is so-called direct between the session server 3 and a terminal 2 when the session server 3 directly sends the data packets of the data stream to this terminal 2. A distribution is so-called indirect between the session server 3 and a terminal 2 when the session server 3 sends the data packets of the data stream to an intermediate device, or relay, for example another server, before the data packets of the data stream are sent to the terminal.

It should be noted that an emitter terminal 2 of a first multimedia stream may, subsequently or simultaneously, be a receiver terminal 2 of a second multimedia stream emitted by another emitter terminal 2 participating to the conference session.

Thus, the conference session may refer to an audioconference wherein terminals 2 may be brought to exchange, almost in real-time, audio streams via a session server 3.

The conference session may also refer to a videoconference wherein terminals 2 may be brought to exchange, almost in real-time, video streams, and possibly audio streams, via a session server 3.

During the conference session, the data packets of the multimedia streams emitted by the terminals 2 are encapsulated according to an Internet protocol. In particular, this protocol is defined in the standard RFC 791.

In the example described herein, the data streams exchanged by the terminals during the conference session are encapsulated according to an RTP (“Real-time Transport Protocol”) or SRTP (“Secure Real-time Transport Protocol”) protocol.

In the present application, a data stream encapsulated according to an RTP protocol should be understood as an UDP data stream (“User Datagram Protocol”) arranged so as to comply with an RTP protocol, i.e. so as to comply with a protocol defined in particular by the standard RFC 3550. In particular, when an RTP data stream is encrypted so as to comply with an SRTP protocol, i.e. in accordance with the standard RFC 3711, we talk about an SRTP data steam.

Moreover, a multimedia stream emitted by an emitter terminal during the conference session is encoded by an encoding codec implemented by the emitter terminal. Depending on the types of data of the multimedia streams, audio and/or video, the encoding codecs are different.

In some examples, an audio encoding codec may correspond to one amongst the following ones: GSM, iLBC, ITU, Speex, LPC, DoD CELP. In some examples, a video encoding codec may correspond to one amongst the following ones: VP8, H264.

Thus, when an emitter terminal 2 emits a multimedia stream during the conference session, the data packets of this multimedia stream are encapsulated according to an Internet protocol, are encoded by an encoding codec, are possibly encrypted by an encryption key, and are then sent to the session server 3 which may, in turn, distribute them to the receiver terminals 2 participating to the conference session.

A terminal 2 may correspond to a fixed or mobile communication device.

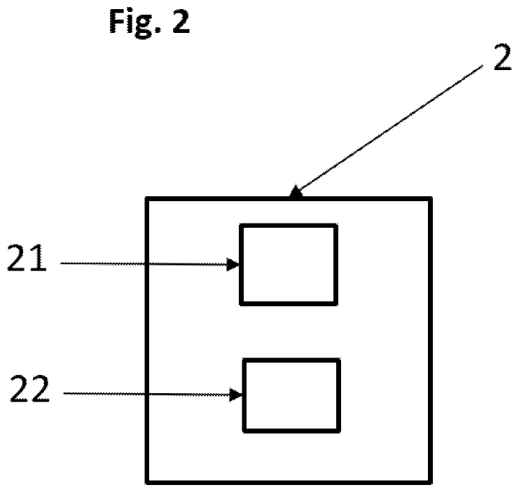

An exemplary terminal 2 is shown in particular in FIG. 2.

In some examples and as illustrated in FIG. 2, the terminal 2 may comprise a microphone 21, or be connected to a microphone 21 as a peripheral, to acquire an audio stream. The terminal 2 may comprise a camera 22, or be connected to a camera 22 as a peripheral, to acquire a video stream.

For example, a session server 3 may correspond to a multimedia server (known as ‘media server’).

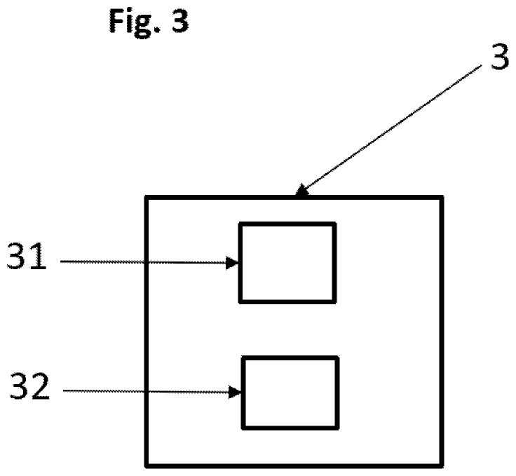

As shown in FIG. 3, the session server 3 comprises a processor 31 configured to control the execution of any one of the embodiments of the method of the present disclosure. The session server 3 may comprise a memory 32 to which the processor 31 has access. The memory 32 may be configured to store the instructions (or code) executed by the processor 31, in particular for the implementation of the method. The memory 32 may also be configured to store multimedia stream data packets that the session server 3 receives from the emitter terminals 2 participating the conference session.

For example, the processor 31 may be of the controller, microprocessor, microcontroller, FPGA type, etc. For example, the memory 32 may comprise a ROM (“Read-Only Memory”) memory, a RAM (“Random Access Memory”) memory, an EEPROM (“Electrically Erasable Programmable Read-Only Memory”) memory or any other suitable types of storage means. For example, the memory may comprise optical, electronic or magnetic storage means.

Referring to FIG. 4, a method for processing multimedia stream data packets of a conference session to which a plurality of terminals 2 participate is now described. This method is implemented by a processor 31 of a session server 3, for example as described hereinbefore. The multimedia stream data packets are sent by at least one receiver terminal 2 amongst the terminals 2 participating to the conference session.

As illustrated by the operation 110, the method 100 herein comprises an identification of the encoding codec implemented by each of the terminals 2 participating to the conference. It consists in determining with which encoding coded each of the terminals 2 encodes the multimedia streams sent thereby to the session server 3.

Afterwards, when the session server 3 receives a plurality of multimedia streams originating from a corresponding plurality of emitter terminals 2 participating to the conference, the method 100 also comprises the implementation of the operations 120, 130 and 140 described hereinafter. The reception of the plurality of multimedia streams by the session server 3 is herein at least partially concomitant. For example, this consists, during an audioconference, in the situation in which a plurality of participants to the audioconference talk at the same time and each of their terminals 2 sends an audio stream to the session server 3. Hence, the session server 3 receives a plurality of audio streams, at least partially simultaneously. During a videoconference, this consists for example of a plurality of participants to the videoconference who have activated their camera and each terminal of which sends a video stream to the session server 3. Hence, the session server 3 receives a plurality of video streams at least partially simultaneously. In other words, the operations 120, 130 and 140 are implemented when the session server 3 receives a plurality of multimedia streams originating from a corresponding plurality of emitter terminals during the same time interval.

As illustrated in FIG. 4, the method 100 comprises an operation 120 of decoding the data packets of the plurality of multimedia streams received from the emitter terminals 2. To the extent that the encoding codec of the multimedia streams of the terminals 2 participating to the conference has been identified during the operation 110 of the method 100, the processor 31 of the session server 3 is capable of decoding the data packets of the multimedia streams received from the emitter terminals 2 by implementing a compatible decoding with the encoding mode implemented by each of the emitter terminals 2.

As illustrated in FIG. 4, the method 100 comprises an operation 130 of mixing the received (and decoded) multimedia stream data packets. In other words, the received streams are mixed with each other to form a unique mixed stream. The receiver terminals 2 refer to the terminals to which the mixed data stream is distributed by the session server 3.

As illustrated in FIG. 4, the method 100 comprises a unique operation 140 of encoding the data packets of the mixed multimedia stream for each group of receiver terminals 2 implementing the same encoding/decoding codec. Hence, the processor 31 of the session server 3 uses, only one time by group of receiver terminals 2 implementing the same encoding/decoding codec, the operation of encoding the mixed stream. Said otherwise, the mixed stream that is still not encoded is duplicated into as many encoded mixed streams as groups of receiver terminals 2 using the same encoding/decoding codec.

Hence, unlike the usual approach, it is no longer necessary to encode a stream as many times as there are receiver terminals. The number of encoding operations is reduced and the necessary resources, in particular those of the processor 31 and of the bandwidth of the networks, are therefore reduced.

In the methods of the prior art, the session servers are generally configured to implement a thread composed of a plurality of instructions (in the form of lines of computer code) for each terminal participating to the conference session in order to distribute to each of the terminals the data packets intended thereto. In these methods of the prior art, each thread is duplicated for each receiver terminal, including when the same stream with the same encoding is transmitted to several terminals. On the contrary, the method according to the present disclosure suggests operating this encoding in one single step for all of the receiver terminals of a mixed stream operating with the same encoding, i.e. therefore sharing the same encoding operation.

In some examples, a unique encoding 140 of the data packets of the mixed multimedia stream for each group of receiver terminals implementing the same encoding/decoding comprises an execution:
of a computer program encoding only once the mixed multimedia stream with a determined encoding codec shared by a group of receiver terminals; then
of a plurality of threads for distributing the mixed and encoded stream, wherein each thread of the plurality of threads is associated with a receiver terminal 2 of the group of receiver terminals and is configured to recover the mixed and encoded stream in order to distribute it to the receiver terminal with which it is associated.

Hence, the method disclosed herein allows avoiding encoding operations to the processor 31 of the session server 3 by using a unique encoding of the mixed stream for each of the receiver terminals of the mixed stream implementing the same encoding codec.

In some examples, when the session server 3 receives a unique multimedia stream originating from a unique emitter terminal 2, the method 100 may comprise the implementation of an operation 220 described hereinafter. The reception of a unique multimedia stream by the session server 3 considered herein refers to a unique multimedia stream emitted by a unique terminal participating to the conference session and received by the session server 3 in a determined time interval. For example, this consists, during an audioconference, in the situation in which only one participant to the audioconference talks while the other participants have deactivated their microphone. Hence, the session server 3 receives a unique audio stream during the determined time interval. During a videoconference, this consists for example in the situation in which one single participant to the videoconference has activated his/her camera while the other participants have deactivated it. Hence, the session server 3 receives one single video stream during the determined time interval.

The operation 220 corresponds to a transfer of the unique multimedia stream originating from the emitter terminal 2 to the receiver terminals 2 implementing the same encoding codec as that one implemented by the emitter terminal 2. This transfer is performed without decoding the data streams of the unique multimedia stream.

These examples allow, in such a situation, avoiding the processor 31 of the session server 3 decoding the multimedia stream emitted by the emitter terminal before distributing it to the receiver terminals sharing the same encoding codec as the emitter terminal. Hence, the processor 31 of the session server 3 saves a decoding operation.

In some examples, the data packets of the multimedia streams emitted by the terminals participating to the conference session are encrypted. This allows protecting the data exchanged by the participant terminals. In this case, this consists of a symmetric encryption system, i.e. the packets of a multimedia stream emitted by a terminal participating to the conference are encrypted with the same encryption key as that one used by this terminal to decrypt the multimedia streams received thereby.

In the examples wherein the data packets of the multimedia streams emitted by the terminals participating to the conference are encrypted, the method 100 may comprise the implementation of an operation 111.

The operation 111 corresponds to obtaining the encryption key that each terminal applies to encrypt the data packets of their own emitted multimedia streams.

In the examples wherein the data packets of the multimedia streams emitted by the terminals participating to the conference are encrypted, and when the session server 3 receives a plurality of multimedia streams originating from a corresponding plurality of emitter terminals participating to the conference, the method 100 may comprise the implementation of the operations 119 and 141. In other words, the method 100 may comprise the implementation of the operations 119 and 141 when the session server 3 receives a plurality of encrypted multimedia streams originating from a corresponding plurality of emitter terminals during the same time interval.

The operation 119 is performed before decoding the data packets of the plurality of multimedia streams received from the emitter terminals performed in the operation 120. The operation 119 corresponds to a decryption of the data packets of the plurality of multimedia streams received from the emitter terminals.

In turn, the operation 141 is performed after the unique encoding of the data packets of the mixed multimedia stream for each group of receiver terminals implementing the same encoding codec (operation 140). The operation 141 corresponds to a unique encryption (meaning “in one single step”) of the mixed and encoded data of the multimedia streams of the terminals of the same group of receiver terminals applying the same encryption key.

Thus, in an embodiment wherein the multimedia streams are encrypted, the method 100 provided for a unique encryption of the mixed and encoded multimedia stream for the terminals of a group of receiver terminals that share the same encryption key. On the contrary, in the methods of the prior art, each thread associated with a receiver terminal comprises instructions for operating an encoding and an encryption so that the encryption is generally implemented as many times as there are receiver terminals. In this embodiment, the method according to the present disclosure suggests, on the contrary, operating the encryption in one single step for the receiver terminals of the same mixed and encoded stream that share the same encryption key. Hence, the processor 31 of the session server 3 saves encryption operations each time there are several receiver terminals that share the same encoding codec and the same encryption key among the receiver terminals of the mixed stream.

In the examples in which the data packets of the multimedia streams emitted by the terminals participating to the conference are encrypted, and when the session server 3 receives a unique multimedia stream originating from an emitter terminal participating to the conference, the method 100 may further comprise the execution of an operation 220′. In other words, the method 100 may comprise the implementation of the operation 220′ when a unique encrypted multimedia stream is received by the session server 3 during a determined time interval.

The operation 220′ corresponds to a transfer of the unique multimedia stream originating from the emitter terminal to the receiver terminals implementing the same encoding codec and applying the same encryption key as the emitter terminal. This transfer is implemented without decrypting or decoding the data packets of this multimedia stream.

These examples allow avoiding the processor of the session server 3 decrypting the multimedia stream before distributing it to the receiver terminals of the conference session sharing the same encoding codec and the same encryption key as the emitter terminal. Hence, the processor 31 of the session server 3 saves a decryption operation in addition to the previously-described decoding operation.

In some examples, when the session server receives two multimedia streams originating from two different emitter terminals participating to the conference and implementing the same encoding codec, the method 100 may further implement an operation 150. In other words, the method 100 may comprise the implementation of the operation 150 when two multimedia streams emitted by two emitter terminals implementing the same encoding coded are received by the session server 3 during the same time interval.

The operation 150 corresponds to the transfer of the multimedia stream received from one emitter terminal to the other emitter terminal, and vice versa, with no mixing or decoding. Thus, the processor 31 of the session server 3 transfers the multimedia stream from the first emitter terminal to the second emitter terminal and transfers the multimedia stream from the second emitter terminal to the first emitter terminal, without any mixing or decoding operation.

Indeed, the emitter terminals do not necessarily receive the same mixed stream as the terminals that are just receiving. In the methods of the prior art, a processing of the multimedia stream distributed to the terminals that are both emitting and receiving is usually operated in order to suppress (filter) their own emitted multimedia stream, in order to avoid the effects of echoes and that the person who is talking hears himself/herself in return. Such a processing is applied independently of the number of terminals emitting simultaneously (two or more than two). During an audioconference, several participants to the audioconference who are talking at the same time do not necessarily wish to hear their own voice in echo. To this end, only the voice of the other participants is transmitted to them. Hence, the session server 3 sends a mixed audio stream to them comprising the voice of the other participants without their own voice, i.e. it sends to them a mixed audio stream comprising the streams of the emitter terminals except their own audio stream.

Yet, the case of two (and not more than two) multimedia streams originating from two different emitter terminals is particular to the extent that a mixing of the two multimedia streams intended for a specific emitter terminal amongst the two emitter terminals may correspond to mixing the two streams of the emitter terminals, and then suppressing (filtering) the multimedia stream of the specific terminal. According to some embodiments of the present disclosure, such a result may be obtained by identifying the situation in which only two terminals are simultaneously emitting, then by transferring the multimedia stream received from an emitter terminal to the other emitter terminal, and vice versa, with no mixing or decoding when these terminals share the same encoding codec. Indeed, each of the emitter terminals is capable of decoding the stream of the other emitter terminals since they share the same encoding codec and it is not necessary to send a mixed multimedia stream thereto since the mixed multimedia stream that will be intended thereto actually corresponds to the multimedia stream of the other emitter terminal. Hence, the session server 3 saves a decoding, mixing and encoding operation for each of the two multimedia streams of the emitter terminals.

In some examples, when the session server 3 receives two encrypted multimedia streams originating from two different emitter terminals participating to the conference, implementing the same encoding codec, and applying the same encryption key, the method 100 may further include an operation 150′. In other words, the method 100 may comprise the implementation of the operation 150′ when two encrypted multimedia streams emitted by two emitter terminals implementing the same encoding codec and applying the same encryption key are received by the session server 3 during the same time interval.

The operation 150′ corresponds to a transfer of the multimedia stream received from an emitter terminal to the other emitter terminal, and vice versa, without any mixing, decoding or decryption. Hence, the processor 31 of the session server 3 saves a decryption, decoding, mixing, encoding and encryption operation for each of the two multimedia streams of the emitter terminals.

In some examples, and as shown in FIG. 4, the method 100 may comprise an operation 115 of determining a rate of utilization of the processor 31 of the session server 3.

In some examples wherein a utilization rate of the processor 31 of the session server is determined as being higher than a determined utilization rate, the method 100 may comprise a management of each multimedia stream received by the session server 3 as a unique multimedia stream originating from a unique emitter terminal participating to the conference. Consequently, in these examples, a multimedia stream received by the session server 3 is transferred to the receiver terminals of this multimedia stream without mixing with the other streams received by the session server and without decoding of this stream for the receiver terminals that share the same encoding codec as the emitter terminal. Hence, the processor 31 of the session server 3 saves a decoding, mixing and encoding operation for each of the receiver terminals of this stream sharing the same encoding codec as the emitter terminal.

Moreover, in the case of an encrypted multimedia stream, this multimedia stream is transferred to the receiver terminals of this multimedia stream without mixing with the other streams received by the session server 3 and without decoding or decryption of this stream for the receiver terminals which share the same encoding codec and apply the same encryption key as the emitter terminal. Hence, the processor 31 of the session server 3 saves a decoding, mixing, encoding and encryption operation of each of the receiver terminals of this stream sharing the same encoding codec and applying the same encryption key as the emitter terminal. In other words, the distribution of the computing load between the session server 3 and the terminals 2 is made flexible and adaptable according to the current load of the session server 3.

Hence, these examples allow reducing the computing resources of the processor 31 of the session server 3 involved when the utilization rate of its processor 31 is high in order to limit the risk of altering the distribution of the multimedia streams, which would be detrimental for the participants to the conference session.

In some examples wherein the multimedia streams correspond to audio streams, the method 100 may further comprise the execution of an operation 125 prior to the execution of the operation 130 of mixing the plurality of multimedia streams received by the session server 3. The operation 125 corresponds to selecting a predetermined number of audio streams having the largest (sound) volumes among the audio data streams received from the emitter terminals. In these examples, mixing of the multimedia streams of the operation 130 is limited to the audio steams selected during the operation 125. This allows distributing to the receiver terminals a mixed stream composed only of the audio streams having the largest volumes in particular to filter the lowest audio streams, which could for example correspond to ambient or parasitic noises around the participants who remain silent without having deactivated their microphone.

Hence, the method according to the present disclosure allows saving computing resources of a processor 31 of a session server 3 ensuring the distribution of the multimedia data streams of a conference session by cleverly aggregating the operations of encoding, and possibly encryption, of the multimedia streams intended for receiver terminals of similar streams (in particular implementing the same encoding) and possibly the same encryption key. Hence, the reduction of the load of the processor 31 of the session server 3 is even more significant as there are participants to the conference session.

Moreover, in some examples, the disclosed method also provides that when the session server 3 receives only one or only two multimedia stream(s) during a determined time interval, the processor 31 executes specific operations which allow saving its computing resources. The Inventor has noticed that, in practice, in a conference session, only one or two participant(s) intervene(s) simultaneously most of the time the session lasts. Consequently, the specific operations proposed to address these particular situations are extremely advantageous and enable the processor to preserve computing resources almost throughout the conference session.

1. A method, implemented by a processor of a session server, for processing multimedia stream data packets of a conference session to which a plurality of terminals participate, the multimedia stream data packets being sent by at least one emitter terminal amongst the terminals participating to the conference session,
wherein multimedia stream data packets emitted by the terminals participating to the conference are encapsulated according to an Internet protocol and are sent to the session server which distributes the multimedia streams to receiver terminals participating to the conference session,
the method comprising:
identifying the encoding codec implemented by each of the terminals participating to the conference; and
when the session server receives a plurality of multimedia streams originating from a corresponding plurality of emitter terminals participating to the conference,
decoding data packets of the plurality of multimedia streams received from the emitter terminals;
mixing received multimedia stream data packets so that a mixed multimedia stream is transmitted to the receiver terminals; and
encoding only once data packets of the mixed multimedia streams for each group of receiver terminals implementing the same encoding/decoding codec.

2. The method according to claim 1, further comprising:
when the session server receives a unique multimedia stream originating from a unique emitter terminal participating to the conference,
transferring the unique multimedia stream originating from the emitter terminal, without decoding the data streams of the unique multimedia stream, to the receiver terminals implementing the same encoding/decoding codec as that one implemented by the emitter terminal.

3. The method according to claim 1, wherein the data packets of the multimedia streams emitted by the terminals participating to the conference are encrypted, the method further comprising:
obtaining the encryption key that each terminal applies to encrypt the data packets of their own emitted multimedia streams; and
when the session server receives a plurality of multimedia streams originating from a corresponding plurality of emitter terminals participating to the conference,
before decoding, decrypting data packets of the plurality of multimedia streams received from the emitter terminals;
after encoding, encrypting only once the mixed and encoded data packets of the multimedia streams of the terminals of the same group of receiver terminals applying the same encryption key, and
when the session server receives a unique multimedia stream originating from an emitter terminal participating to the conference,
transferring the unique multimedia stream originating from the emitter terminal, without decrypting data packets of this multimedia stream, to the receiver terminals of each group of receiver terminals implementing the same encoding/decoding codec and applying the same encryption key as the emitter terminal.

4. The method according to claim 1, wherein
when the session server receives two multimedia streams originating from two different emitter terminals participating to the conference and implementing the same encoding codec, the method further comprises:
transferring the multimedia stream received from one emitter terminal to the other emitter terminal, and vice versa, without mixing or decoding.

5. The method according to claim 3, wherein, when the session server receives two multimedia streams originating from two different emitter terminals participating to the conference implementing the same encoding codec and having the same encryption key, the method further comprises transferring the multimedia streams from one emitter terminal to the other emitter terminal, and vice versa, without mixing, decoding or decrypting by the session server.

6. The method according to claim 2, wherein the method comprises the following prior step:
determining a utilization rate of the processor of the session server; and
when the utilization rate of the processor of the session server is higher than a predetermined utilization rate,
managing each multimedia stream received by the session server as a unique multimedia stream originating from a unique emitter terminal participating to the conference.

7. The method according to claim 1, wherein a multimedia stream corresponds to an audio stream or a video stream.

8. The method according to claim 7, wherein the multimedia streams correspond to audio streams, the method further comprising, before mixing the multimedia streams:
selecting a predetermined number of audio streams having the largest volumes among the audio data streams received from the emitter terminals;
and wherein mixing of the multimedia streams corresponds to a limited mixing with the selected audio streams.

9. The session server comprising a processor configured to implement the methods according to claim 1.

10. The computer program product including instructions for the implementation of the methods according to claim 1 when this program is executed by a processor.
